(19) United States
(12) Patent Application Publication
(10) Pub. No.: US 2014/0314904 A1
(43) Pub. Date: Oct. 23, 2014

(54) PRE-SLAUGHTER DIET INCLUDING METHIONINE

(71) Applicant: ADISSEO FRANCE S.A.S., Antony (FR)

(72) Inventor: Pierzynowski Stefan, Trelleborg (SE)

(21) Appl. No.: 14/357,279

(22) PCT Filed: Nov. 9, 2012
(86) PCT No.: PCT/EP2012/072241

§ 371 Date: May 9, 2014

(30) Foreign Application Priority Data
Nov. 9, 2011 (SE) 1151056-7

(51) Int. Cl. A23K 1/16; A23L 1/318

(52) U.S. Cl. CPC A23K 1/1634; A23L 1/318
USPC 426/2; 426/656; 426/645

(57) ABSTRACT

The present invention provides novel method for improving the tenderness of meat (e.g. pork, beef and poultry). The method comprises a pre-slaughter diet comprising methionine in an amount effective to improve the tenderness of the meat. The methionine may be fed alone or in combination with feedstuff rations to livestock animals. The present invention provides a novel use of methionine, i.e. for improving the tenderness of meat. The invention includes the use of methionine analogues such as 2-Hydroxy-4-Methyl Thio Butanoic acid (HMTBA) or all its salt forms or 2-Hydroxy-4-Methyl Thio Butanoic isopropyl ester or any of other esters.

### TECHNICAL FIELD

The present invention relates to the field of fresh meat quality, from e.g. pork. Particularly, the present invention relates to the packing atmosphere of fresh meat and its effect on meat quality, particularly oxidative stability and texture, and how to improve the quality of fresh meat packed in a modified atmosphere or in vacuum by a pre-slaughter diet by supplementation of methionine.

### BACKGROUND OF THE INVENTION

Fresh meat is often packed in high-oxygen modified atmosphere packaging. This packaging atmosphere usually consist of a mixture around 80% O₂ and 20% CO₂. The high concentration of CO₂ inhibits aerobe bacterial growth and prolongs the shelf life of meat. The high level of O₂ provides a consumer desired stable red meat colour, but it also promotes oxidation of macronutrients in the meat. Oxidation of macronutrients can affect the eating quality of meat. Lipid oxidation is known to affect flavour, and protein oxidation is associated with decreased tenderness.

Packaging is important to prolong shelf life of meat and make distribution of products more efficient. It protects a given product against the outside environment and deteriorative effects such as; pathogens, discolouration, off-flavour, off-odour, texture changes, & nutrient loss.

Packaging has, as mentioned above, been shown to have an effect on meat quality like colour, flavour, water holding capacity and microbial growth. High oxygen MAP promotes lipid oxidation and blooming of myoglobin pigments to oxymyoglobin, and is suspected to influence meat tenderness negatively. Vacuum packaging influences meat colour, vacuum packed meat is often purple because the lack of oxygen causes the myoglobin pigments to form deoxymyoglobin. If a little amount of oxygen is left in the vacuum pack, the meat can turn brown because of formation of metmyoglobin.

After slaughtering the muscle cells are more susceptible to oxidative processes, than they would be in the living animal. The availability of oxygen and exposure to light are two main factors in reactive oxygen species (ROS) formation and thereby oxidation in meat. Processing, high oxygen packaging, and storage can all contribute to ROS formation and hence oxidation potential of the product. The significant ROS in meat are hydrogen peroxide, hydroxyl radicals, perhydroxyl, superoxide, and singlet oxygen.

Oxidative processes in meat affects almost all biological molecules and hence the overall quality of the meat. Pigments, fatty acids, vitamins, and amino acids are the biological molecules most affected by the oxidative processes (McMillin, K. W, “Where is MAP Going? A review and future potential of modified atmosphere packaging for meat.”, Meat Science 2008, vol. 80, p. 43-65 2008). The oxidation of these molecules is known to affect quality aspects such as colour, flavour, and odour in meat (Kanner, J. (1994): “Oxidative Processes in Meat and Meat Products: Quality Implications.” Meat Science 1994, vol. 36, p. 169-189). Lipid oxidation is known to discolour the meat and give the meat a rancid flavour. Protein oxidation is suggested to influence meat digestibility, hence nutritional value, tenderness, flavour, and water-holding capacity.

WO2009/032276 provides a method of improving tenderness of meat comprising administering at least one form of beta-agonists to at least one bovine animal. However, these types of beta-agonists are currently prohibited in several countries and regions such as Europe.

WO 2005/002358 provides a method for improving meat quality of animals, wherein the method comprises feeding the animal a diet supplemented with mixed tocotrienols. However, tocotrienols will only prevent lipid oxidation and not protein oxidation.

U.S. Pat. No. 6,042,855 provides a method of improving the tenderness of meat and meat products. The method includes administering excessive doses of vitamin D to meat producing animals prior to slaughter. The excessive dose of vitamin D is thought to improve quality of meat by a higher intramuscular calcium content, which, on other hand, is weakening myofibrils in muscles.

The effect of packaging atmosphere on flavour and tenderness of meat provides a dilemma for both manufacturers and consumers, as there are both advantages and disadvantages with high-oxygen modified atmosphere packaging. Inhibiting bacterial growth is important for food safety and shelf life, and consumers prefer red meat, as they associate this with fresh unspoiled meat. Oxidation changes the eating quality of the meat. The rancid flavour caused by lipid oxidation and the decreased tenderness caused by protein oxidation are not desirable, as consumers tend to prefer tender meat with no off-flavour. It is therefore highly desirable to be able to inhibit the oxidation of proteins associated with meat tenderness.

There is thus an urgent need to develop means and methods for improving meat quality, such as tenderness of fresh meat, particularly when packed in a modified atmosphere. Accordingly, the present invention seeks to provide means and methods to address such needs and interests for fresh meat packaging.

### SUMMARY OF THE INVENTION

One aspect of the present invention provides use of methionine for improving meat quality, such as tenderness and oxidative stability of colour and shelf life stability of meat. Such use may be wherein the methionine is administered as a pre-slaughter diet.

The meat may further be fresh meat or frozen meat. However, all meat is non-human meat and may be non-human mammalian meat, avian meat or fish meat. The meat may thus be selected from the group consisting of pork, beef, hen, chicken, turkey, fish.

The methionine may be a methionine supplementation formulation comprising at least one further feed-stuff, such as L-methionine. Further examples are wherein the methionine is DLM (i.e. DL-methionine) or HMTBA (i.e. 2-hydroxy-4-(methylthio) butanoic acid). The methionine may be in the form of L-methionine, such as in the form of synthetic methionine sources. It may be L-methionine in all its salt forms, its analogues (e.g. 2-Hydroxy-4-Methyl Thio Butanoic acid or all its salt forms), derivatives (e.g. 2-Hydroxy-4-Methyl Thio Butanoic isopropyl ester or any of other esters), or mixtures thereof.

Said meat may be stored under vacuum or high oxygen conditions.

Said methionine may be administered as 0.1-1 g, such as 0.1, 0.2, 0.25, 0.3, 0.35, 0.4, 0.45, 0.5, 0.55, 0.6, 0.65, 0.7, 0.75, 0.8, 0.85, 0.9, 0.95 or even 1 g of total methionine per kg body weight per day pre-slaughter.

In another aspect, the methionine is administered as 0.3-0.6% above recommended daily dose. The daily dosage may vary between different species. However, such recommendations are readily available to someone skilled in the art of animal feed for different species.

Thus, the dose of extra methionine as part of the uses, methods and pre-slaughter diets according to the invention herein is thus easily calculated based on this to have an effect on meat quality such as tenderness, oxidative stability of colour of the fresh meat and shelf life of said fresh meat. The methinone may be administered on day −30 to −1 pre-slaughter.

Thus, the methionine is, in a further aspect used for improving meat quality, such as tenderness and oxidative stability of colour and shelf life stability of meat.

Doses and days of feeding said methionine is given above and is for all embodiments also applicable for the use in improving meat quality. Particularly, methionine is used in a dose of 0.1-1 g, such as 0.1, 0.2, 0.25, 0.3, 0.35, 0.4, 0.45, 0.5, 0.55, 0.6, 0.65, 0.7, 0.75, 0.8, 0.85, 0.9, 0.95 or even 1 g of total methionine per kg body weight per day pre-slaughter. In another aspect, the methionine is used in a dose of 0.3-0.6% above recommended daily dose. For both aspects of dosing the methionine is administered on day −30 to −1 pre-slaughter.

In a further aspect, a method of improving meat quality, such as tenderness and oxidative stability of colour and shelf life stability of meat in animals is included. Said method comprises the step of pre-slaughter administering methionine in an effective amount to a non-human mammal or avian species. The administration to said non-human mammal or avian species may be done orally and preferably may be done through a drinking water administration. The methionine may be administered on day −30 to −1 pre-slaughter. The methionine is in the method also administered in the same doses as in the uses herein, i.e. in a dose of 0.2-1 g, such as 0.2, 0.25, 0.3, 0.35, 0.4, 0.45, 0.5, 0.55, 0.6, 0.65, 0.7, 0.75, 0.8, 0.85, 0.9, 0.95 or even 1 g per kg body weight per day of total methionine. It may, in another aspect be administered as a dose of 0.3-0.6% above recommended daily dose intake.

Further, an animal pre-slaughter diet comprising methionine is described herein.

In the pre-slaughter diet the methionine is fed on day −30 to −1 pre-slaughter in a dose of 0.1-1 g, such as 0.1, 0.2, 0.25, 0.3, 0.35, 0.4, 0.45, 0.5, 0.55, 0.6, 0.65, 0.7, 0.75, 0.8, 0.85, 0.9, 0.95 or even 1 g per kg body weight per day as total methionine to a non-human animal or in a dose of 0.3-0.6% above recommended daily dose intake. The pre-slaughter diet may further comprise at least one further feedstuff to non-human mammals or avian species. Still a further aspect of the present invention is to provide meat from a slaughtered animal, said animal being fed with a pre-slaughter diet comprising methionine according to the invention or according to any of the methods and uses herein. Still a further aspect of the present invention provides a product comprising meat at least partially from a slaughtered animal, said animal being fed with a pre-slaughter diet comprising methionine according to the invention or according to any of the methods and uses according to the invention.

Thus, the present invention provides a method for improving the tenderness of meat which comprises the step of administering methionine as a pre-slaughter diet to an animal. The meat may be avian meat or fish meat or non-human mammal. More precisely, the meat may be selected from the group consisting of pork, beef, hen, chicken, turkey, fish.

According to the method of the present invention, the methionine may be administered in the form of a methionine supplementation formulation.

The administered methionine may be in the form of L-methionine, or in the form of synthetic methionine sources such as DLM (i.e. DL-methionine) or all of its salt forms, its analogues (e.g 2-Hydroxy-4-Methyl Thio Butanoic acid or all its salt forms), its derivatives (e.g. 2-Hydroxy-4-Methyl Thio Butanoic isopropyl ester or any of other esters), or mixtures thereof.

According to the method of the present invention, the methionine may be administered as 0.1-1 g, such as 0.1, 0.2, 0.25, 0.3, 0.35, 0.4, 0.45, 0.5, 0.55, 0.6, 0.65, 0.7, 0.75, 0.8, 0.85, 0.9, 0.95 or even 1 g, of total methionine per kg body weight per day pre-slaughter to the animal.

According to the method of the present invention, the methionine may be administered to the animal as 0.3-0.6% above recommended daily dose.

According to the method of the present invention, the methionine may be administered on day −30 to −1 pre-slaughter. And more preferably, the administration of methionine is done orally to the animal.

The present invention provides an animal pre-slaughter diet comprising methionine and wherein the methionine is fed on day −30 to −1 pre-slaughter in a dose of 0.1-1 g per kg body weight per day to the animal or in a dose of 0.3-0.6% above recommended daily dose intake. The pre-slaughter diet may further comprise at least one further feedstuff to the animal.

The present invention provides a meat from a slaughtered animal, said animal being fed with a pre-slaughter diet comprising methionine as described above.

The present invention provides a product comprising meat at least partially from a slaughtered animal, said animal being fed with a pre-slaughter diet comprising methionine as described above.

The present invention concerns the use of methionine for improving the tenderness of avian meat or fish meat or non-human mammal. And more preferably, the methionine may be in the form of L-methionine, or in the form of synthetic methionine sources such as DLM or all of its salt forms, its analogues (e.g 2-Hydroxy-4-Methyl Thio Butanoic acid or all its salt forms), its derivatives (e.g. 2-Hydroxy-4-Methyl Thio Butanoic isopropyl ester or any of other esters), or mixtures thereof.

### BRIEF DESCRIPTION OF THE DRAWINGS

FIG. 1 shows the sEMG Peak-to-Peak amplitudes (mV) measured at various frequencies (60, 150 & 200 Hz) for pigs in the CONTROL (n=3) (no DLM) as open squares, the DLM pre n=6 as filled circles; post n=6 as black circles and the HMTBA (n=3) groups as black squares.

FIG. 2 shows mean shear force values of the DLM (1), Control (2), and HMTBA (3) groups.

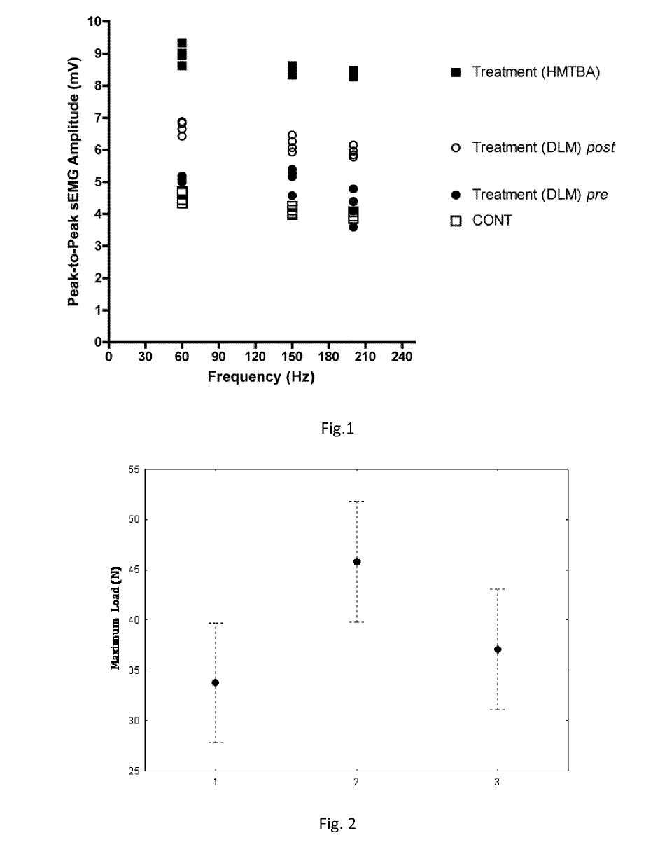

### DETAILED DESCRIPTION OF THE INVENTION

### Definitions

As used herein “prior to harvest” is intended to mean pre-harvest or pre-slaughter of the animal.

As used herein, the singular forms “a”, “and”, and “the” include plural referents unless the context clearly dictates otherwise.

As used herein “at least one” is intended to mean one or more, i.e. 1, 2, 3, 4, 5, 6, 7, 8, 9, 10, etc.

As used herein “animal” is intended to mean non-human mammals, avian species, e.g. poultry, and/or fish depending on the context. Further examples are given herein.

As used herein, a “full dose feed” is intended to mean a feed that is complete in respect of nutrients, proteins, vitamins and minerals and used as a daily feed for an animal. Normally, an animal eats a certain percentage, %, of the full dose feed per day per kg of body weight (bw). Examples are given herein.

As used herein “meat” includes meat as raw material, fresh and frozen meat whatever the situation allows. Further, “meat” is animal flesh that is used as food. “Meat” further means the skeletal muscle and associated fat and other tissues, but it may also describe other edible tissues such as organs and offal. In the Anglosphere, “meat” is generally used by the meat packing industry in a more restrictive sense—the flesh of mammalian species (pigs, cattle, lambs, etc.) raised and prepared for human consumption. As a matter of clarification, as used herein “meat” is not to be interpreted in such a restrictive way but to further include meat from other species such as poultry, fish, and other animals. Also, meat as raw material is used for further processing of meat and is included in the term “meat” herein.

It is an objective of the present invention to provide means and methods to improve meat quality such as tenderness and oxidative stability of meat and meat products.

It is further an objective to provide means and methods for improving tenderness of non-human mammal meat, such as beef, pork and of poultry, i.e. avian species, meat and meat products from swine, poultry (non-ruminants) and cattle (ruminants).

It is further an objective of the present invention to provide means and methods for improving tenderness of said meat which does not affect flavour of the meat.

It is further an objective of the present invention to provide means and methods for improving tenderness of meat and meat products which is safe, simple and cost effective.

It is a further object to provide means and methods to provide an anti-stress diet to an animal pre slaughter to improve quality, such as tenderness and oxidative stability, of meat. Improved oxidative stability will further increase shelf life of the meat. The meat to be improved is fresh meat from healthy animals, i.e. slaughter animals.

It is also a further object of the present invention to provide means and methods for reducing oxidative stress in animals, such as animal, e.g. a pig, poultry or fish, by using methionine in a diet. Such stressfully situations may be e.g. slaughter, weaning, encaging and/or transport situations or any other situation causing stress.

Thus, the methionine diet clearly seems to have a calmative/anti-stress effect on these animals such as e.g. a pig, poultry or fish slaughter weight pigs or slaughter hogs, which are exposed to exactly the same level of handling and measurement stress as the untreated animals such as pigs. Such an anti-stress diet would use any of the suggested doses herein for the pre-slaughter diet, i.e. in a total dose of about 0.5-1 g, such as e.g. 0.6-0.9 g per 100 g of feed to the animal, e.g. a pig, poultry or fish, e.g. 0.5, 0.55, 0.6, 0.65, 0.7, 0.75, 0.8, 0.85, 0.9, 0.95 or even 1 g per 100 g of feed as a dose. This is about 0.6-0.9% in the feed. Of this, about 0.25%, i.e. 0.25 g/100 g feed, represents methionine from proteins in the feed.

Thus, the addition of extra methionine to affect tenderness of meat amounts for about 0.3-0.6 g/100 g or 3-6 g/1000 kg feed, i.e. 0.3-0.6% above the normal feeding dose. Such an anti-stress diet would similarly be fed on day −30 to −1, i.e. 30 days before to 1 day before slaughter, that is pre-slaughter, e.g. −30, −29, −28. −27, −26, −25, −24, −23, −22, −21, −20, −19, −18, −17, −16, −15, −14, −13, −12, −11, −10, −9, −8, −7, −6, −5, −4, −3, −2, to −1 days pre-slaughter, or −25 to −1 days pre-slaughter, or −20 to −1 day pre-slaughter or −14 to −1 day pre-slaughter, in a dose of about 0.3-0.6% over recommended methionine dose/day/kg bwt to have an effect on oxidative stress by reducing the oxidative stress.

Quality of meat may be measured by pH, meat colour and sensory characteristics, such as oxidation of lipid and proteins affecting tenderness of the meat.

The present invention measures meat quality as of e.g. colour of packed meat as well as colour of meat upon cocking, tenderness and oxidative state stored under different conditions, such as low oxygen, vacuum, or high oxygen such as modified atmosphere, e.g. modified oxygen packaging (MAP). In MAP the air is first removed by vacuum or gas flushing and then replaced by another gas mixture before sealing in barrier materials. In vacuum packaging (VP) the air is removed and not replaced, before the product is sealed in barrier materials.

As used herein, modified atmosphere packaging, MAP, is intended to mean that the atmosphere surrounding the product is removed and/or replaced before sealing in vapour-barrier materials. Different MAP options are contemplated herein and exemplified, such as master packs, low O₂ and high O₂ MAP. Many forms of MAP are also case-ready packaging, so the cutting and packaging of meat happens at a centralized location before transport to the retail stores. This type of case-ready packaging will of course also benefit of the present invention and is thus contemplated herein.

Further, low O₂ MAP may be vacuum packaging or MAP with an anoxic headspace. Vacuum is almost completely air-free, while a mix of N₂ and CO₂ may commonly be used as anoxic headspace in low O₂ MAP. Carbon monoxide (CO) may also be used in some low O₂ MAP to prevent browning of meat, but CO is illegal to use in the European Union.

High O₂ MAP has a headspace with high concentration of O₂ in comparison with atmospheric air (atmospheric air: ˜78% N₂, 20.99% O₂, 0.94% argon, 0.03% CO₂). Gas mixtures in high O₂ MAP usually have a mixture of 80% O₂ and 20% CO₂, but it may be varied around 25-90% O₂ and 15-80% CO₂. After packaging there is no additional manipulation of the internal environment, even though the gas atmosphere may change due to changes in environment and product.

MAP may also be used in master packs, where a number of individual packages are placed in a larger barrier wrapping with a modified atmosphere. Further, the individual packages may be air-permeable, but the master pack is MAP. Thus, when the master pack is opened, an individual package with air-permeable packaging materials will no longer be considered MAP. Tray-in-sleeve systems are another way of combining the advantages of MAP and air-permeable packaging. Instead of a master pack, the individual package has a removable barrier wrapping, which can be removed when desirable, leaving an underlying air-permeable wrapping.

Methionine to be used in the methods, uses, pre-slaughter diet according to the invention may be added in the form of L-methionine, such as in the form of synthetic methionine sources. It may be L-methionine in all its salt forms, its analogues (e.g. 2-Hydroxy-4-Methyl Thio Butanoic acid or all its salt forms), derivatives (e.g. 2-Hydroxy-4-Methyl Thio Butanoic isopropyl ester or any of other esters), or mixtures thereof.

The methionine dose to feed the animal with f.ex., by adding to a full dose feed of a pre-slaughter diet or alone, should be in an amount effecting meat quality, such as tenderness and oxidative stability of meat according to the invention. Methionine is normally part of an animal feed, but in a non-effective amount.

Thus, according to the invention, the animal is fed with the pre-slaughter diet in a dose effecting tenderness of meat according to the methods and uses and dose-regimes given herein and within the scope of the invention.

Meat quality may then be measured as tenderness, texture and oxidative stability of lipids or proteins of the meat. Methods are given herein. Both texture and oxidative stability affects the tenderness of the meat. Colour is also an indicative of meat quality. One is merely visual base on the packed fresh meat, i.e. a buyer prefers a particular colour of the packed fresh meat, normally red meat colour. Oxidation makes the meat more brownish and is thus less attractive to a buyer. A pre-slaughter diet comprising methionine according to the invention will lead to lower oxygen consumption in the package due to the protective mechanism of methionine. In this way, the shelf life of the meat will increase and the colour during storage will be preserved.

However, colour is also an indication of cocking temperature of meat; it reflects coagulation of the proteins by a colour change (browning). Normally, meat changes colour during cocking and the coagulation is reflected in a browning process. Meat packed in a modified atmosphere with high oxygen changes colour at a lower temperature during cocking; i.e. at about 20° C. lower temperature than meat packed in a normal atmosphere. This will of course be detrimental to the one who prepare the meat and trust the colour change as being ready for eat. Particularly, the aspect of killing bacteria and denaturing toxic substances during cocking will be lost if the meat will change colour to show coagulation at about 52° C. instead of about the correct temperature at 72° C. Thus, the consumer of the meat will be at risk of eating raw meat with bacteria still alive and toxic substances still working albeit looking at the colour shift when cocking the meat.

Thus, a further aspect of the present invention is that the pre-mature browning seen during cocking of meat stored in high oxygen packing will also be prevented using methionine pre-slaughter, alone or in a pre-slaughter diet. Thus, accordingly, the pre-slaughter diet comprising methionine will further increase meat quality by improving shelf life stability of fresh meat, improving colour stability of fresh meat during storage, as well as preventing pre-mature browning during cocking.

Using methionine pre-slaughter also affects shelf life of meat. The use of methionine pre-slaughter will increase the oxidative stability of the meat, thus less oxygen is consumed during storage. And with less oxygen consumption one may store the meat longer with the same amount of oxygen. The same is true for colour of packed meat in high oxygen modified atmospheres where the meat from methionine fed animals will be more oxidative stable and thus preserve red meat colour longer with the same amount of oxygen. The present invention affects the tenderness off the meat so as to improve the tenderness. Oxidation of proteins affects meat tenderness negatively.

Tenderness may be measured as “instrumental hardness” using the Warner-Bratzler shear force (WBSF; Newton, see e.g. Bouton, P. E. and Harris P. V. (1972) A comparison of some objective methods used to asses meat tenderness. J. Food Sci. 37, 218-221). Protein oxidation may be measured as the loss of free thiol groups in proteins (μM thiol per mg protein) using Ellman's reagent, see e.g. Lund and Baron (2010) Protein Oxidation in foods and food quality. In: Skibsted et al (ed): Chemical deterioration and physical instability of food and beverages. Page 33-69, Woodhead Publishing Limited ISBN 978-1-84569-495-1. Lipid oxidation may be measures as the increase in 2-thiobarbituric acid reactive substances (TBARS; mg malondialdehyde per kg meat, see e.g. Creed, P. G (2010) Chemical deterioration and physical instability in ready-to-eat meals and catered foods. In Skibsted et al (ed): Chemical deterioration and physical instability of food and beverages. Page 608-661, Woodhead Publishing Limited ISBN 978-1-84569-495-1).

The invention is believed to be effective on ruminant cattle, e.g. cow, as well as horse, lamb, bison, swine and poultry, e.g. hen, chicken, turkey, emu, ostriches, and further fish, e.g. salmon.

Thus, the pre-slaughter diet comprising administering methionine, as well as its methods and uses to improve tenderness according to the invention may be practiced on any animal, i.e. non-human animals, e.g. bovine animals e.g. cows, porcine animals, e.g. pigs, equine animals, e.g. horses, caprine animals, e.g. goats, ovine animals, e.g. sheep, poultry, e.g. hen, chicken, turkey, emu, ostriches or fish.

The methionine is preferably administered or fed orally in e.g. a feedstuff by itself or as a supplement to a typical feedlot feedstuff, including roughages, such as hay or silage, and concentrates such as grains, e.g. corn, barley, milo, rye, oats and wheat, and mixtures thereof along with e.g. molasses and other supplements and additives for livestock.

However, the methionine may also be administered by other routes, such as intraperitoneal, intravenous or subcutaneous injections, transdermal application, or by water dosiometry.

For oral administration it may be in the form of powder, grains, pellets, a small sphere, or any other small, solid or densely packed ball, mass or tablet.

In another embodiment of the invention, the administration of the methionine may be done through a drinking water administration.

Accordingly, one object of the present invention is the use of methionine, in its natural or synthetic form, its analogues, derivatives, or mixtures, thereof for improving tenderness of meat, alone or in a pre-slaughter diet. Methionine, in its natural or synthetic form, its analogues, derivatives or mixtures thereof, is available commercially from several sources. Tenderness may be evaluated as texture or WBSF used as a measure of instrumental hardness (N). Using methionine will improve the meat quality as of tenderness and make the meat more tender. The methionine is fed as a pre-slaughter diet. The meat affected may be both fresh meat or frozen meat, and when fresh meat being vacuum packed or packed in a modified atmosphere with high oxygen.

In one embodiment, the methionine, when fed as a pre-slaughter diet is affecting tenderness of fresh meat. The meat may, as described herein, be any non-human animal or mammalian meat. For example, it may be meat from pork, cattle, avian meat, e.g. meat from poultry, or meat from fish. It may also be any met selected from the group consisting of pork, beef, hen, chicken, turkey.

The methionine may, as described elsewhere herein, be wherein the methionine is any methionine, natural or synthetic, its analogues (e.g 2-Hydroxy-4-Methyl Thio Butanoic acid or all its salt forms), derivatives (e.g. 2-Hydroxy-4-Methyl Thio Butanoic isopropyl ester or any of other esters), or mixtures thereof or mixtures thereof, or a methionine supplementation formulation. It may be L-methionine in all its salt forms. For example, it may be DLM (i.e. DL-methionine) or HMTBA (i.e. 2-hydroxy-4-(methylthio) butanoic acid).

Said meat may be stored under vacuum or high oxygen conditions, or any modified atmosphere packaging. Different MAP options are contemplated herein and exemplified, such as master packs, low O₂ and high O₂ MAP, e.g. as exemplified further herein.

As revealed above, the animal is fed with the pre-slaughter diet in a dose effecting tenderness of meat according to the methods and uses and dose-regimes given herein and within the scope of the invention.

The amount of feed intake varies from species to species. A growing pig up to about 100 kg body weight, for example, eat about 3-5%, such as e.g. 4%, of their bodyweight per day, whereas a broiler, e.g. a chicken, may eat up to 10% of their body weight per day. Thus, an animal will eat about 1-10% of its body weigh per day in feed intake. Thus, the dose of methionine per kg body weight and per day is defined and adjusted in concentration to fit the daily intake of feed in included as a total-pre-slaughter diet feed with methionine.

Examples of such pre-slaughter diets, when full diets, affecting meat quality such as tenderness and oxidative stability of shelf life and colour of meat are given below.

The methionine may, of course, be given separately, and not in the daily full-diet ration, administering the same dose of methionine. However, this will need extra labour to administer to the animal in addition to the daily diet feed and is thus less desirable. However, it will give the same effect on tenderness of meat.

The methionine according to the invention is fed in a total dose of about 0.5-1 g, such as e.g. 0.6-0.9 g per 100 g of feed to the animal, e.g. a pig, poultry or fish, e.g. 0.5, 0.55, 0.6, 0.65, 0.7, 0.75, 0.8, 0.85, 0.9, 0.95 or even 1 g per 100 g of feed as a dose. This is about 0.6-0.9% in the feed. Of this, about 0.25%, i.e. 0.25 g/100 g feed, represents methionine from proteins in the feed. Thus, the addition of extra methionine to affect tenderness of meat amounts for about 0.3-0.6 g/100 g or 3-6 g/1000 kg feed, i.e. 0.3-0.6% above the normal feeding dose.

Example of a standard full diet for pigs is given here below, excluding the extra methionine according to the invention.

### Content:

Wheat 54.9%; Barly 16.9%; Wheta brun i 10.0%; oats 9.5%; Soy 4.4%; Rape, extracted 1.5%; Calcium carbonate 1.5%; Common salt 0.34%

### Nutritive Content:

Crude protein 12.5%; Crude fat 2.8%; Ashes 4.6%; Crude fibre 5.0%; Ca 0.6%; P 0.4%; K 0.6%; N 2.0%; Na 0.15%; Metionine 2.4 g (from proteins per 1000 g feed); Lysine 7.9 g per 1000 g feed of which hydroxy analogue is 0.5 g; Energy acc. Swedish Board of Agriculture, (Jordbruksverket), SJV, 12.2 MJ; Energy acc. to Swedish University of Agricultiral Science, (Sveriges lantbruksuniversitet), SLU, NEväx 9.3 MJ; Energy acc. to Swedish University of Agricultiral Science, (Sveriges lantbruksuniversitet), SLU, NEsugg 9.5 MJ

### Different Types of Additives and Example of Amounts:

Selenium (natriumselenit) 0.4 mg; Cupper (cupper sulfate) 15 mg; Vitamine E 60 mg; Vitamine D3 400 IE; Vitamine A 4000 IE; L-lysine tekniskt rent; L-treonine tekniskt rent; monomersyrahalt Fytas EC 3.1.3.26 415 FTU of total phosphorus, P.

An extra methionine dose according to the invention is then added as 0.3-0.6% over recommended methionine dose/day/kg body weight (bwt) or about 12-24 g extra added methionine/1000 g feed.

The dose per kg animal thus relates to the amount of feed the animal eats, if not changing the methionine concentration, that is the amount of methionine/1000 g feed ration. Both options are of course available in the methods, uses and pre-slaughter diets according to the invention.

For example, a pig of 100 kg eating 2-6% of its body weight (bwt), for example eating 4% of its bodyweight per day of the pre-slaughter diet according to the invention, i.e. 4 kg of the pre-slaughter diet if 4%. The pig will have a total dose of 24 g to 36 g methionine per day. Of this, 12-24 g/1000 g feed, i.e. 0.3-0.6% of total feed weight, is extra added methionine, for example L-methionine, to the feed to have an effect on meat quality, e.g. tenderness and oxidative stability of colour and shelf life stability of meat.

Pre-slaughter doses of methionine for other species is calculated from amount of daily consumed feed enriched with extra enrichment of 0.3-0.6% of methionine over recommended methionine dose/day/kg bwt to have an effect on meat quality such as tenderness and oxidative stability of colour and shelf life of fresh meat.

The methionine is thus fed as 0.1-1 g per kg body weight per day of total methionine, i.e. both the methionine in the feed from proteins as well as the extra methionine of 0.3-0.6% over the recommended methionine dose/day/kg bwt, such as 0.1, 0.2, 0.25, 0.3, 0.35, 0.4, 0.45, 0.5, 0.55, 0.6, 0.65, 0.7, 0.75, 0.8, 0.85, 0.9, 0.95 or even 1 g per kg body weight per day pre-slaughter of total methionine intake.

Further, the methionine is fed on day −30 to −1, i.e. 30 days before to 1 day before slaughter, that is pre-slaughter, e.g. −30, −29, −28. −27, −26, −25, −24, −23, −22, −21, −20, −19, −18, −17, −16, −15, −14, −13, −12, −11, −10, −9, −8, −7, −6, −5, −4, −3, −2, to −1 days pre-slaughter, or −25 to −1 days pre-slaughter, or −20 to −1 day pre-slaughter or −14 to −1 day pre-slaughter, in a dose of about 0.3-0.6% over recommended methionine dose/day/kg bwt to have an effect on meat quality such as tenderness and oxidative stability of colour and shelf life of fresh meat packed in vacuum or in any modified atmosphere such as high oxygen atmosphere.

Thus, methionine is used for improving tenderness of meat and a further object is methionine for use in improving meat quality, e.g. meat tenderness, using methionine as describe herein in methods, uses and pre-slaughter diets. Also included is use of methionine for the preparation of a pre-slaughter diet for improving meat quality and use of methionine for the preparation of a medicament or animal feed for reducing oxidative stress in an animal.

Accordingly, further objects of the present invention is a method for improving tenderness of meat from non-human mammals or avian species, said method comprising the step of pre-slaughter administering methionine in an effective amount to a non-human mammal or avian species. Examples of effective amounts are given herein, e.g. 0.1-1 g per kg body weight per day, such as 0.1, 0.2, 0.25, 0.3, 0.35, 0.4, 0.45, 0.5, 0.55, 0.6, 0.65, 0.7, 0.75, 0.8, 0.85, 0.9, 0.95 or even 1 g per kg body weight per day pre-slaughter.

Further, the methionine is fed on day −30 to −1, i.e. 30 days before to 1 day before slaughter that is pre-slaughter.

For example, a methionine supplementation strategy is tested in a rather straight forward way and examples given herein.

To test oxidative stability of pork loins on may do as follows.

An increase of oxidative stability due to methionine supplementation strategies fed pre-slaughter will improve tenderness of meat such as e.g. pork loins.

One may chose a suitable number of animals, such as pigs, to perform a study with its control groups, f. ex. twenty-one pigs randomly assigned to one of three feeding groups (n=7). The control group may receive a standardized feedlot diet only. The groups to be tested with the pre-slaughter diet are fed with methionine in its natural or synthetic form, e.g. L-methionine, its analogues, derivatives, or mixtures thereof, for improving meat quality, here assessed as tenderness of meat. Examples of L-methionine are DLM (DL-methionine) and HMTBA (DL-2-hydroxy-4-methylthiobutanoic acid). The groups will receive the standardized feedlot diet and a high-methionine supplement, e.g. for example either DLM (i.e. DL-methionine) or HMTBA (i.e. 2-hydroxy-4-(methylthio) butanoic acid), during the finishing period before slaughter—from 1-30 days. To test different conditions of storage e.g. vacuum and high oxygen, and then analyse effect of methionine fed pre-slaughter on meat tenderness, the meat is packed under different specified conditions. If f.ex. pork is analysed, pork chops are either vacuum packed or packed in modified atmosphere (MA; 80% O₂) and stored for an additional 7 days at 2° C. 48 h post mortem. F.ex. 3 cm thick pork chops may be either vacuum packed or packed in modified atmosphere (MA; 80% O₂) and stored for an additional 7 days at 2° C. before analysing meat quality by assessing e.g. tenderness of the meat.

Tenderness may then be analysed as instrumental hardness using the Warner-Bratzler shear force (WBSF; Newton). Protein oxidation may be measured as the loss of free thiol groups in proteins (μM thiol per mg protein) using Ellman's reagent. Lipid oxidation may be measured as the increase in 2-thiobarbituric acid reactive substances (TBARS; mg malondialdehyde per kg meat).

Experiments, shown as results herein, shows that both methionine supplementation strategies resulted in markedly more tender meat, i.e. WBSF values is lower when measured, than the control diet when stored under vacuum. This was also the case for the meats stored under modified atmosphere, i.e. MAP meat, however, the difference in WBSF values between DLM and HMTBA groups were bigger, indicating a better tenderization of the DLM samples during storage in oxidative conditions.

The method according to the invention may be a method wherein the administration to said non-human mammal or avian species is done orally, or in any further way exemplified herein such as by other routes, such as intraperitoneal, intravenous or subcutaneous injections, transdermal application, or by water dosiometry. For oral administration it may be in the form of powder, grains, pellets, a small sphere, or any other small, solid or densely packed ball, mass or tablet. The methionine may be administered alone, or as a supplement to a typical feedlot feedstuff, including roughages, such as hay or silage, and concentrates such as grains, e.g. corn, barley, milo, rye, oats and wheat, and mixtures thereof along with e.g. molasses and other supplements and additives for livestock.

Further, the administration of methionine according to the invention may be done on day −30 to −1 pre-slaughter, as exemplified further herein. Further, the methionine administered may be in a dose of 0.1-1 g per kg body weight per day pre slaughter, such as 0.1, 0.2, 0.25, 0.3, 0.35, 0.4, 0.45, 0.5, 0.55, 0.6, 0.65, 0.7, 0.75, 0.8, 0.85, 0.9, 0.95 or even 1 g per kg body weight per day pre-slaughter, or any dose per day corresponding to about 0.3-0.6% over recommended methionine dose/day/kg bwt to have an effect on meat quality such as tenderness and oxidative stability of colour and shelf life of fresh meat.

A further object of the invention is thus to provide an animal, e.g. non-human mammalian or avian, pre-slaughter diet comprising methionine and wherein the methionine is fed on day −30 X to −1 Xx pre-slaughter in a dose of 0.2-1 g per kg body weight per day pre-slaughter, such as 0.1, 0.2, 0.25, 0.3, 0.35, 0.4, 0.45, 0.5, 0.55, 0.6, 0.65, 0.7, 0.75, 0.8, 0.85, 0.9, 0.95 or even 1 g per kg body weight per day pre-slaughter, or any dose per day corresponding to about 0.3-0.6% over recommended methionine dose/day/kg bwt to have an effect on meat quality such as tenderness and oxidative stability of colour and shelf life of fresh meat. The pre-slaughter diet may further comprise a further feedstuff to non-human mammals or avian species. Such feed-stuff is further exemplified herein and may be e.g. roughages, such as hay or silage, and concentrates such as grains, e.g. corn, barley, milo, rye, oats and wheat, and mixtures thereof along with e.g. molasses and other supplements and additives for livestock.

Further objects of the present invention is to provide meat from a slaughtered animal, said animal being fed with a pre-slaughter diet comprising methionine according to the invention, e.g. the pre-slaughter diet, methods and uses described herein in all its embodiments.

Still, a further object of the present invention is to provide a product comprising meat at least partially from a slaughtered animal, said animal being fed with a pre-slaughter diet comprising methionine according to the invention e.g. the pre-slaughter diet, methods and uses described herein in all its embodiments.

Administration of the methionine, its analogues, derivatives, or mixtures thereof, at the dosage schedule pre-slaughter according to the invention and as described herein in all its embodiments has shown to improve the tenderness of fresh meat, packed in vacuum or in a modified atmosphere packaging (MAP).

Thus, the present invention in all its objects and embodiments affects tenderness of non-human animal meat. This is accomplishes through administration of methionine, its analogues, derivatives, or mixtures thereof, (i.e. the methionine may be in the form of L-methionine, such as in the form of synthetic methionine sources, in all its salt forms, its analogues (e.g. 2-Hydroxy-4-Methyl Thio Butanoic acid or all its salt forms), derivatives (e.g. 2-Hydroxy-4-Methyl Thio Butanoic isopropyl ester or any of other esters), or mixtures thereof), to livestock in an amount effective to improve tenderness of meat and without being toxic to the livestock prior to harvest of the animal.

### EXAMPLES

The Examples 1 below shows the relation between methionine supplementation strategies and oxidative stability of pork chops. The results show that methionine supplementation strategies will increase the oxidative stability and improve tenderness of pork loins.

### Example 1

In Example 1 twenty-one pigs were randomly assigned to one of three feeding groups (n=7). The control group received a standardized diet only. The DLM and HMTBA groups received the standardized diet plus a high-methionine supplement (either DLM (i.e. DL-methionine) or HMTBA (i.e. 2-hydroxy-4-(methylthio) butanoic acid)) during the finishing period. At 48 h post mortem, 3 cm thick pork chops were either vacuum packed or sealed in a modified atmosphere (MA; 80% O₂) and stored for an additional 7 days at 2° C. Instrumental hardness was measured using the Warner-Bratzler shear force (WBSF; Newton) method. Protein oxidation was measured as the loss of free thiol groups in proteins (nmol thiol per mg protein) using Ellman's reagent. Lipid oxidation was measured as the increase in 2-thiobarbituric acid reactive substances (TBARS; mg malondialdehyde per kg meat).

The DLM supplementation strategy tended to lower instrumental hardness in both non-oxidative (vacuum) and oxidative (MAP) environments. DLM exhibited the highest level of free thiol in the non-oxidative environment and the lowest level of free thiol in the oxidative environment. A significant decrease in the level of free thiol was only seen for this group. The DLM supplementation strategy seemed to possess the ability to improve the tenderness of pork chops stored under oxidative conditions to the same level as pork chops from the control group stored under vacuum conditions.

Diet seemed to have no effect on lipid oxidation in the meat. The lack of diet effect may be caused by an impaired reliability of the method of measuring the level of TBARS. The TBARS levels were at an equal level for vacuum packed pork chops and this was lower than the TBARS levels seen during MA (modified atmosphere) storage. During MA storage, the two methionine treatments resulted in a similar TBARS level, which was markedly lower than the level of the control samples.

### Material and Methods Example 1

### Animals and Feeding Strategies

Twenty-one slaughter pigs ([Yorkshire×Swedish Landrace]×Hampshire) were raised on a commercial diet. Pigs were randomly assigned to one of three groups (n=7). The groups represented three feeding strategies, namely a Control group which received a standardized diet comprising 0.27% total methionine, and both a DLM and HMTBA group, receiving the same diet as the Control group throughout the feeding period, apart from the fact that they were fed a higher level of methionine (1.1% total methionine) during a seven day finishing period immediately prior to slaughter. The supplements were given in two forms, either as D L-methionine (DLM) or DL-2-hydroxy-4-methylthiobutanoic acid (HMTBA). The pigs were fed twice daily 2% of their body weight with the respective diets and had free access to water.

### Slaughter and Sampling Procedures

Pigs were slaughtered at a commercial slaughter house in Sweden after a resting time of 5 hours. At 45 minutes post mortem, pH (Knick portamess 751 pH-meter with an Ingold LOT glass electrode, Tech Instrumentering ApS, Denmark) and temperature (digital thermometer, Weber, Stephen Nordic, Denmark) were measured in the m. Longissimus dorsi (LD) at the level of the 10^{th} rib. At 48 hours post mortem, the entire back was dissected from the carcass and transported under controlled conditions to the University of Copenhagen for further measurements.

### Packaging and Ageing

Pork chops were cut perpendicular to the long axis of each LD muscle. Six 3 cm thick pork chops was sliced from each LD. Three were vacuum packed and three were packed in a high-oxygen modified atmosphere. The chops were placed in plastic trays (M71-43A white/PS; 195×144×43 mm in dimension; Frch Plast, Denmark) and placed in vacuum bags (EM-628862; O₂ transmission rate=40-50 cm³/m²/24 h/bar, CO₂ transmission rate=150 cm³/m²/24 h/bar, water-vapour transmission rate=2.6 g/m²/24 h; LogiCon Nordic A/S, Denmark). The ambient air was removed from all vacuum bags using a vacuum machine (type, manufacturer, country). The bags intended for vacuum storage were first filled with a gas mixture (80% oxygen/20% carbon dioxide) before being sealed completely, whereas the bags intended for MAP were only partially sealed. This procedure resulted in a headspace-to-meat ratio in the MAP samples of approximately 8:1. The chops were displayed in full light (LUX?) for 7 days at 2° C. (until 9 days post mortem). The gas composition was checked (CheckMate 9900, PBI Dansensor, Denmark) before packaging and again prior to opening, at the end of the simulated display period in order to check for leakage. The oxygen-enriched environment was well maintained (83.4%) throughout the display period for all MA packages.

### Storage Loss and Cooking Loss

Storage loss was determined as the weight loss percentage at the end of the display period (9 days post mortem) relative to the weight at the day of packaging (two days post mortem). The cooking loss was determined as the weight loss percentage between the pork chops before and after cooking. The results are given as the mean of the three pork chops in each meat pack.

### Meat Colour (CIE L*a*b*)

Instrumental meat colour was measured with a Minolta Chroma Meter (CR-300; D₆₅ and 2° observer angle, 8 mm diameter measuring area; Minolta, Japan). Before packaging, as described previously, colour recordings of the pork chops was carried out. At the end of the display period, the pork chops were allowed to bloom for at least 30 min at 4±2° C. once they had been removed from the vacuum bags. Colour measurements followed the CIE colour convention, where the three fundamental outputs are L*, a* and b*. L* is lightness on a scale of 0 (all light absorbed; black) to 100 (all light reflected; white); a* spans from +60 (red) to −60 (green) and b* spans from +60 (yellow) to −60 (blue). The saturation index, also known as chroma, was calculated as the square root of a*²+b*² (MacDougall, 1977). Three recordings were made on each pork chop, and the mean value was used for statistical analysis.

### Warner Bratzler Shear Force (WBSF)

Instrumental hardness was measured using the Warner-Bratzler shear force (WBSF) method. In short, at the end of the display period fresh samples were heated in a water bath in an oven (type, manufacturer, country). The temperature rise was monitored for one sample and the remaining samples were given the time to reach an internal temperature of 75° C. plus five minutes. The samples were cooled down before cores of 1 cm×1 cm×2.5 cm were excised for shear force analysis. For each animal, 8 cores were measured and the mean maximum load (Newton) was used for further analysis. In the case that any of the specimens had a maximum load in excess of two standard deviations from the mean, then they were regarded as outliers and taken out of the calculation.

### Free Protein Thiol

Protein oxidation was measured as the loss of free thiol groups in proteins, hence high values indicate low oxidation and vice versa. In brief, the frozen pork samples were partially thawed at chill storage temperature for 30 minutes. Fat and connective tissue was removed and 1.0 g of lean meat was homogenised in 25 ml of 5.0% SDS (sodium dodecyl sulphate) in 0.10 M Tris (tris(hydroxyamino)methane) buffer, pH 8.0 using an Ultra Turrax (Ultra Turrax T-25, Janke & Kunkel IKA-Labortechnik, Germany). The homogenates were placed in a water bath at 80° C. for 30 minutes, and subsequently cooled and filtered. The protein concentration was determined spectrophotometrically (Helios Omega Single Beam UV-VIS, Fisher Scientific Biotech Line, Denmark) at a wavelength of 280 nm using a standard curve prepared from bovine serum albumin (BSA). The thiol concentration was determined in an ELISA plate reader (SLT Spectra Rainbow, FO 39046, SLT LABinstruments, Austria) after derivatization by Ellman's reagent; 5,5′-dithiobis-(2-nitrobenzoic acid=DTNB) (Ellman, 1959) in 0.10 M Tris-buffer (pH 8.0). Filtrate (25 μl), Tris buffer (100 μl) and DTNB (25 μl) were added to wells in a 96 well microtiter plate. The absorbance at 410 nm was measured before addition of DTNB (ABS410ₘₑₐₜ) and after reaction with DTNB (ABS410_{meat+DTNB}). In addition, the absorbance of a blank solution (25 μl 5% SDS dissolved in 100 mM Tris buffer and 100 μl 0.10 M Tris buffer) was likewise measured at 410 nm. After addition of DTNB, the microtiter plate was stored in the dark and the absorbance was measured exactly 30 minutes later. The absorbance corresponding to the thiol concentration in the sample was CorrABS410=ABS410_{meat+DTNB}−ABS410ₘₑₐₜ−ABS410_{blank}. The thiol concentration was calculated based on a 7-point standard curve ranging from 2 to 150 μg/ml glutathione prepared from reduced glutathione diluted in 5.0% SDS in 0.1 M Tris buffer, pH 8.0. The concentration of free thiol groups was determined as nmol thiol per mg protein. Duplicate homogenates, and triplicate measurements on each homogenate, were made for each meat sample and the mean values were used for further statistical analysis.

### Thiobarbituric Acid Reactive Substances (TBARS)

Lipid oxidation was measured as the increase in 2-thiobarbituric acid reactive substances (TBARS) and expressed as mg malondialdehyde per kg meat. Lipid oxidation was evaluated using 2-thiobarbituric acid (TBA; 4,6-dihydroxy-2-mercapto-pyrimidin) as described by (Vyncke, 1970; Vyncke, 1975) with modifications according to (Sorensen & Jørgensen, 1995). Briefly, 5.0 g meat was homogenized in 15 ml 7.5% TCA with 0.10% propylgallate and 0.10% ethyldiamin-tetra acedic acid (EDTA) using an Ultra Turrax (Ultra Turrax T-25, Janke & Kunkel IKA-Labortechnik, Germany) for 45 seconds at 13,500 rpm and filtered. 5.0 ml of the filtrate was mixed with 5.0 ml 0.020 M thiobarbituric acid (TBA) and incubated at 100° C. in a waterbath for 40 minutes. Absorbance was measured at 532 nm and 600 nm at room temperature. The TBARS results were calculated using a standard curve prepared from malondialdehydbis-(diethylacetal) (TEP). Mean values of two independent determinations were used for statistical analysis.

### Extraction of Lipid

The amount of extractable lipid was used to calculation the total lipid content of the fresh meat samples and was expressed as a percentage. A meat sample (10 g) was homogenized in 100 ml chloroform/methanol (2:1 v/v) using an Ultra Turrax (Ultra Turrax T-25, Janke & Kunkel IKA-Labortechnik, Germany) for 1 minute at 13,500 rpm. To this homogenate was added 25 ml of a 1.0 mM CaCl₂ solution and the material was once again homogenized before centrifugation (MSE Mistral 2000, England) for 20 minutes at 1,000 rpm. The chloroform phase was removed and the extraction procedure repeated. The chloroform phase containing the extracted lipids was dried by vacuum evaporation (Buchi RE 11, Buchi Laboratoriums-Technik AG, Schweiz). Finally, 2×2 ml chloroform/methanol and 2.0 ml CaCl₂ were added to the dried sample which was then mixed (Vortex-mixer VF2, Janke & Kunkel IKA_Labortechnik, Germany) and centrifuged for 20 minutes at 2,500 rpm. The lipid phase was removed, dried by vacuum evaporation and weighed. The percentage of intramuscular fat was calculated from the weight of the total lipid obtained after solvent extraction and the weight of the meat sample.

### Statistical Analysis

The storage loss, cooking loss, colour, hardness and protein oxidation data were analysed using a split-plot design in ANOVA with random effect of animal ID. For the fixed effects a full factorial design of (diet, packaging) was adopted. Least squares means for all traits of interest were separated using the least significant differences (F test, P<0.05). Model validation was performed for each model to ensure fulfillment of the model assumptions. All LS-mean combinations were adjusted for multiple comparisons using the Tukey test. The lipid oxidation data was analysed using a paired-sample t-test. Model validation was performed to ensure fulfillment of the model assumptions.

### Results Example 1

### Storage and Cooking Loss

The storage and cooking loss data were determined as the weight reduction (g) before and after the display period as well as before and after cooking. Least squares means of the main effects are shown in Table 1. Whilst packaging and diet showed a slight tendency towards an interaction (P=0.098) with respect to storage loss, storage loss was significantly affected by the packaging conditions (P<0.0001) in that display under vacuum led to lower storage loss than display in MAP. However, the storage loss of the HMTBA samples stored under vacuum was not significantly different from those stored in a high-oxygen atmosphere (P=0.58). There was no overall effect of diet (P=0.14).

Cooking loss was not affected by an interaction between packaging and diet (P=0.54) or diet alone (P=0.68). However, there was an overall effect of packaging conditions (P=0.0011), which was not reflected in Table 1. Numerically, display under vacuum led to a higher cooking loss than display in MAP.

TABLE 1
Storage and cooking loss data from slaughter pigs fed a
standard diet with (DLM and HMTBA) or without (Control)
methionine supplementation. Data are expressed as the weight
reduction (g) before and after the display period and before
and after cooking. Results are reported as least squares
mean ± the standard error of the mean.

| | |
|---|---|
| Vacuum | MAP¹ |

Storage loss

| | | |
|---|---|---|
| Control | 4.94 ± 0.83 ^{B} | 9.64 ± 0.83 ^{A} |
| HMTBA | 4.63 ± 0.83 ^{B} | 6.37 ± 0.83 ^{A, B} |
| DLM | 4.56 ± 0.89 ^{B} | 9.34 ± 0.83 ^{A} |

Cooking loss

| | | |
|---|---|---|
| Control | 23.34 ± 1.73 ^{A} | 17.51 ± 1.73 ^{A} |
| HMTBA | 21.35 ± 1.73 ^{A} | 18.49 ± 1.73 ^{A} |
| DLM | 21.52 ± 1.86 ^{A} | 15.82 ± 1.86 ^{A} |

¹Modified atmosphere packaging (80% O2 + 20% CO2).
^{A, B} LS-means with the same letter are not significantly different.,
^{B} LS-means with the same letter are not significantly different.

### Meat Colour

The colour characteristics of the meat samples were determined using the CIE L*a*b* colour system. Least squares means of the main effects are shown in Table 2. Packaging and diet interacted (P=0.037) with respect to light reflection. The light reflection at two days post mortem (initial) was not significantly different from the light reflection after seven days of chill storage (vacuum and MAP) for the Control and HMTBA samples. The conditions) but not during vacuum ageing (a non-oxidative environment). The Control diet showed a numerically lower initial light reflection than the DLM and HMTBA methionine supplements. During vacuum ageing, the light reflection increased in the Control and DLM groups but decreased in the HMTBA group. During chill storage in a high-oxygen modified atmosphere, the light reflection increased for all three groups.

TABLE 2
Colour properties of meat from slaughter pigs fed a standard diet with (DLM
and HMTBA) or without (Control) methionine supplementation. The results
are reported as least squares mean ± the standard error of the mean.

| | | |
|---|---|---|
| Initial¹ | Vacuum¹ | MAP¹ |
| (2 days post | (9 days post | (9 days post |
| mortem) | mortem) | mortem) |

Light reflection (L*)

| | | | |
|---|---|---|---|
| Control | 54.64 ± 1.25 ^{A, B} | 57.80 ± 1.44 ^{A, B} | 57.78 ± 1.25 ^{A, B} |
| HMTBA | 56.89 ± 1.25 ^{A, B} | 55.34 ± 1.25 ^{A, B} | 58.73 ± 1.30 ^{A, B} |
| DLM | 55.75 ± 1.25 ^{B} | 57.83 ± 1.25 ^{A, B} | 59.19 ± 1.30 ^{A} |

Redness (a*)

| | | | |
|---|---|---|---|
| Control | 7.56 ± 0.58 ^{A, B, C, D} | 8.51 ± 0.63 ^{A, B, C, D} | 8.09 ± 0.58 ^{A, B, C, D} |
| HMTBA | 7.58 ± 0.58 ^{B, D} | 8.86 ± 0.58 ^{A, C} | 7.43 ± 0.59 ^{B, D} |
| DLM | 6.69 ± 0.58 ^{C, D} | 8.21 ± 0.58 ^{A, B} | 7.83 ± 0.59 ^{A, B, C, D} |

Yellowness (b*)

| | | | |
|---|---|---|---|
| Control | 3.00 ± 0.46 ^{C} | 8.76 ± 0.57 ^{A, B} | 6.91 ± 0.46 ^{A, B} |
| HMTBA | 3.71 ± 0.46 ^{C} | 8.39 ± 0.46 ^{A} | 6.35 ± 0.49 ^{B} |
| DLM | 2.92 ± 0.46 ^{C} | 8.11 ± 0.46 ^{A, B} | 7.10 ± 0.49 ^{A, B} |

Saturation index

| | | | |
|---|---|---|---|
| Control | 8.16 ± 0.67 ^{D, E} | 12.23 ± 0.76 ^{A, B} | 10.70 ± 0.67 ^{A, B, C} |
| HMTBA | 8.46 ± 0.67 ^{C, D, E} | 12.22 ± 0.67 ^{A} | 9.81 ± 0.69 ^{B, C, D, E} |
| DLM | 7.33 ± 0.67 ^{E} | 11.55 ± 0.67 ^{A, B, C} | 10.55 ± 0.69 ^{A, B, C, D} |

¹Initial colour determination at two days post mortem. Vacuum packaging and MAP = modified atmosphere packaging (80% O2/20% CO2) of pork chops which were chill stored for an additional 7 days.
^{A, B, C, D, E} Different superscripts between means (based on each colour property separately) indicate significant differences (P < 0.05).

There was no significant packaging and diet interaction for redness (P=0.16). However, the redness was significantly affected by packaging (P<0.0001) but not by diet (P=0.82). The Control samples exhibited similar redness readings at the beginning of the storage period and after 7 days of chill storage, regardless of the packaging system applied. The HMTBA and DLM samples had similar redness at the beginning of the storage period and after seven days of chill storage in the high-oxygen MAP. Moreover, the redness increased significantly in the HMTBA (P=0.033) and DLM (P=0.0058) samples after seven days of chill storage under vacuum. In addition, the HMTBA samples showed significant difference in redness between the two packaging systems applied (P=0.020).

There was no significant packaging and diet interaction for yellowness (P=0.21). However, the yellowness was significantly affected by packaging (P<0.0001) but not by diet (P=0.94). The yellowness of the samples increased significantly during chill storage, more so during vacuum storage than MAP. The HMTBA samples also differed significantly between vacuum and a high-oxygen storage (P=0.0092), whereas the Control samples only showed a tendency towards a difference between vacuum and MAP storage (P=0.075) and the DLM samples showed no difference between the packaging systems applied (P=0.56).

There was no packaging and diet interaction for the saturation index (P=0.15). However, the saturation index was significantly affected by packaging (P<0.0001) but not by diet (P=0.81). The saturation index of the Control and DLM samples increased significantly from the initial index to the index after the vacuum and MAP display periods (P<0.001). However, the HMTBA supplementation did not increase the saturation index significantly during MAP storage but instead resulted in a significant difference between the two storage conditions (P=0.0014).

### Warner-Bratzler Shear Force (WBSF)

WBSF was used as a measure of instrumental hardness (N). The WBSF values were significantly lower for the vacuum packed pork chops than those chops stored in a high-oxygen MAP during the 7 day display period (P<0.0001). There was no significant effect of diet, however, a tendency was observed towards a diet effect (P=0.059). Numerically, both the DLM and HMTBA groups showed markedly lower WBSF values than the Control group within each packaging system. In fact, the DLM supplementation strategy showed a strong tendency towards lower WBSF values compared to the Control diet (P=0.055). In addition, the “hardness” of the methionine treated samples stored in a high-oxygen MAP was found to be equal to the “hardness” obtained from the vacuum packed control samples, see Table 3.

TABLE 3
Instrumental hardness data from slaughter pigs fed a
standard diet with (DLM and HMTBA) or without (Control)
methionine supplementation. Data are expressed as WBSF
values (Newton, N) and the results are reported as least
squares mean ± the standard error of the mean.

| | Vacuum | MAP¹ |
|---|---|---|
| Control | 39.90 ± 3.65 ^{B, C, D} | 51.69 ± 3.65 ^{A} |
| HMTBA | 30.55 ± 3.65 ^{C, D} | 43.64 ± 3.65 ^{A, B} |
| DLM | 28.80 ± 3.65 ^{D} | 38.58 ± 3.65 ^{A, B} |

¹Modified atmosphere packaging (80% O2 + 20% CO2).
^{A, B, C, D} LS-means with the same letter are not significantly different.

### Free Protein Thiol

Protein oxidation was measured as the decline in the level of free thiol (nmol thiol/mg protein). Least squares means of the main effects are shown in Table 4. Packaging and diet showed a tendency towards an interaction (P=0.091). Methionine supplementation seemed to increase the level of free protein thiol when the meat samples had been stored under vacuum (a non-oxidative environment) but decrease the level of free protein thiol when the meat samples had been stored in MAP (oxidative conditions). Hence, meat from pigs supplemented with DLM differed significantly in the level of free thiol between the two packaging strategies (P=0.0012). Whilst there was a strong similar tendency towards a difference within the HMTBA group, this remained insignificant with the present sample size (P=0.056), moreover, no difference was found for the Control group (P=0.51). It can be concluded though that the content of free thiol groups was significantly affected by the packaging method applied (P<0.0001), in that samples stored under vacuum exhibited a significantly higher amount of free thiol groups than those samples stored in MAP.

TABLE 4
Protein oxidation data from slaughter pigs fed a standard
diet with (DLM and HMTBA) or without (Control) methionine
supplementation. Data are expressed by the level of free
thiol (nmol thiol/mg protein) and the results are reported
as least squares mean ± the standard error of the mean.

| | Vacuum | MAP¹ |
|---|---|---|
| Control | 60.56 ± 1.13 ^{A, B} | 58.49 ± 1.19 ^{A, B} |
| HMTBA | 62.60 ± 1.13 ^{A} | 59.15 ± 1.13 ^{A, B} |
| DLM | 62.16 ± 1.19 ^{A} | 56.27 ± 1.13 ^{B} |

¹Modified atmosphere packaging (80% O2 + 20% CO2).
^{A, B} LS-means with the same letter are not significantly different.

### Thiobarbituric Acid Reactive Substances (TBARS) and Muscle Fat Content

TBARS was used as a measure of lipid oxidation (mg malondialdehyde/kg meat). There was no significant effect of diet (P=0.41).

### Discussions and Conclusions Experiment 1

All reactions and chemical tests are prone to some degree of un-specificity or interference, and the present study is no exception. Under the conditions used, DTNB is also known to react with sulphite, thiosulfate, hydrogen sulphite, cyanide, and sulphide, all of which may therefore have interfered with the SH determination (Ref). Likewise, in principal, any substance carrying a sulphur containing anion at pH 8 will also react with DTNB (Hofmann & Hamm, 1978). Moreover, methionine (10 μg) has been found to give a yellow colour in the presence of DTNB and hence, interfere with the determination of thiol groups at pH 8.0 in a 0.5 M phosphate buffer (Owens & Belcher, 1965).

Pork chops stored under a vacuum were found to possess lower WBSF values (e.g. were more tender) than chops stored in a high-oxygen MAP. In many ways this was to be expected as lower tenderness is a well-known phenomenon of fresh meat stored in a high-oxygen MAP (Tørngren, 2003; Sørheim et al., 2004; Clausen et al., 2009; Lund et al., 2007). However, this study has sought to establish if two types of methionine supplementation formulations, DLM and HMTBA, are capable of improving the oxidative stability and the tenderness of pork chops stored in a high-oxygen atmosphere. There was no overall effect of diet in relation to instrumentally determined hardness. However, numerically, both the DLM and HMTBA groups showed markedly lower WBSF values than the Control group (>8 Newton), within each packaging system (Table 3). The DLM supplementation strategy showed a strong tendency towards lower WBSF values than the Control diet (P=0.055). This indicates that the DLM treatment results in better tenderisation post mortem regardless of the storage conditions applied. In addition, the “hardness” of the DLM treated samples stored in a high-oxygen MAP was found to be equal to the “hardness” obtained from the vacuum packed Control samples (Table 3). This would seem to indicate that the DLM supplementation strategy has the ability to improve the tenderness of pork chops stored under oxidative conditions to the same level as that of pork chops of non-supplemented pigs stored under optimal conditions, namely a vacuum.

The level of free thiol was highest in the vacuum stored meat and lowest in meat stored in MAP, indicating a higher level of protein oxidation in the latter. In addition, the free thiol level of the DLM and HMTBA groups were numerically higher than that of the Control group when the samples were stored without oxygen. When the meat was stored in an oxidative environment, the level of free thiol was reduced within all dietary strategies. The Control group showed a difference of 1.8 units between vacuum and MAP. The level of free thiol of the HMTBA and DLM groups declined by 3.5 and 6.0 units, respectively, from storage without oxygen to storage in a high-oxygen MAP.

It may seem contradictory that DLM resulted in the most tender meat both when displayed under vacuum and when stored in MAP and at the same time exhibited both the highest (vacuum) and lowest (MAP) level of free thiol, respectively. However, methionine is able to scavenge ROS, to target proteins for proteolytic degradation, is involved in cell signalling and is likely involved in the regulation of enzyme activities (Stadtman et al., 2003). These biological processes may affect both the oxidative stability of fresh meat and the tenderisation process of meat post mortem. It may be speculated that the higher level of free thiol seen in the DLM samples stored without oxygen reflected an improved proteolytic susceptibility of the meat proteins, which would result in improved tenderisation. During storage in an oxidative environment, the targeting of proteins for proteolytic degradation by methionine may be overshadowed by its antioxidative behaviour. As methionine act as an antioxidant through a radical scavenging mechanism (Stadtman et al., 2003), meaning that it is readily oxidized in order to prevent or delay oxidation of key proteins, the level of free thiol groups should decrease to a higher extent when meat is stored in an oxidative environment if elevated levels of methionine is present. This coincides well with the results found in the present study. Without the antioxidative effect of methionine, conformational changes in proteins may occur (Stadtman et al., 2003). This might help explain why hardness increased during storage in high-oxygen MAP compared to vacuum storage.

Regarding lipid oxidation, no effect of diet was obtained from the valid paired-sample t test. It was not possible to determine the effect of packaging as the raw data showed heterogeneous variance. The heterogeneity seemed to be related to the packaging systems applied, and thereby the level of oxygen in the packaging system. It was considered likely that the variance differed between packaging systems in that vacuum (without oxygen) would have a low variance because the sample material is un-oxidized whereas MAP (high oxygen level) would result in a rather large variance due to the (uneven) oxidation taking place. By consulting the raw data, it was apparent that the TBARS levels were equal for vacuum packed pork chops, regardless of feeding strategy applied (1.47 to 1.72 mg malondialdehyde/kg meat) and this was lower than the TBARS levels seen during MA storage. During MA storage, the two methionine treatments resulted in equal TBARS levels (4.99 mg malondialdehyde/kg meat), which was numerically lower than the level of the control samples (7.08 mg malondialdehyde/kg meat)

### Example 2

### sEMG (Surface Electromyography), sECG (Surface Electrocardiography) and Respiration Measurements

### Animals and Feed—Low, Normal and High Methionine

### Diet 007—Low Methionine:

Material amount %:
Wheat 37.17; Barly 35.0; Soya brun (Hipro 46% protein) 15.0; Wheta brun 10.0 Phosphoran 0.5; NaCl 0.35; Minerals additives 0.3; Vitamin additives 0.03; L-lizyne (tech clean) 0.15. Total: 100.0

Component Amount in 1000 g in g: dry matter 881; Lizine 9.67; Methionine 2.52; Tryptofan 2.23; Treonin 6.39; Arginin 11.4; Row protein 169; Ca 8.98; Na 1.58; Fiber 32.5; Histidine 4.57; lso-leucin 6.89; Lecin 13.0; Valine 8.33; Fenylalenine+tyrozine 14.3; Mg 1.94; K 7.69; Mg 155 mg; J 2.45 mg; Cu 36.3 mg; Fe 273 mg; S 1.97 g; Zn 214 mg; Co 1 308 mg; Se 0.636 mg; Vit A Int. U. 15 080; Vit D3 In.U. 3 000; Vit E 60.3 mg; Vit K3 1.5 mg; VitB1 6.98 mg; Vit B6 8.15 mg; Vit B12 30.6 mg; Bitin 0.237 mg; Folic acid 1.53 mg; Nicotine acid 88.2 mg; Pantoteic acid 21.3 mg; cholin 1 564 mg; Linolic acid 2 805 mg; Ash 42.9 g.

### Diet 008—Normal Methionin

Material amount %: Wheat 37.17; Barly 35.0; Soya brun (Hipro 46% protein) 15.0; Wheta brun 10.0; Phosphoran 0.5; NaCl 0.35; Minerals additives 0.3; Vitamin additives 0.03; L-lizyne (tech clean) 0.15; Total 100.0

Component Amount in 1000 g in g:dry matter 881; Lizine 9.67; Methionine 3.99; Tryptofan 2.23; Treonin 6.39; Arginin 11.4; Row protein 169; Ca 8.98; Na 1.58; Fiber 32.5; Histidine 4.57; Iso-leucin 6.89; Lecin 13.0; Valine 8.33; Fenylalenine+tyrozine 14.3; Mg 1.94; K 7.69; Mg 155 mg; J 2.45 mg; Cu 36.3 mg; Fe 273 mg; S 1.97 g; Zn 214 mg; Co 1 308 mg; Se 0.636 mg; Vit A Int. U. 15 080; Vit D3 In.U.3 000; Vit E 60.3 mg; Vit K3 1.5 mg; VitB1 6.98 mg; Vit B6 8.15 mg; Vit B12 30.6 mg; Bitin 0.237 mg; Folic acid 1.53 mg; Nicotine acid 88.2 mg; Pantoteic acid 21.3 mg; cholin 1 564 mg; Linolic acid 2 805 mg; Ash 42.9 g.

### Diet 009—High Methionin

Material amount %: Wheat 37.17; Barly 35.0; Soya brun (Hipro 46% protein) 15.0; Wheta brun 10.0; Phosphoran 0.5; NaCl 0.35; Minerals additives 0.3; Vitamin additives 0.03; L-lizyne (tech clean) 0.15; Total 100.0

Component Amount in 1000 g in g: dry matter 881; Lizine 9.67; Methionine 7.41; Tryptofan 2.23; Treonin 6.39; Arginin 11.4; Row protein 169; Ca 8.98; Na 1.58; Fiber 32.5; Histidine 4.57; Iso-leucin 6.89; Lecin 13.0; Valine 8.33; Fenylalenine+tyrozine 14.3; Mg 1.94; K 7.69; Mg 155 mg; J 2.45 mg; Cu 36.3 mg; Fe 273 mg; S 1.97 g; Zn 214 mg; Co 1 308 mg; Se 0.636 mg; Vit A Int. U.15 080; Vit D3 In.U.3 000; Vit E 60.3 mg, Vit K3 1.5 mg; VitB1 6.98 mg; Vit B6 8.15 mg; Vit B12 30.6 mg; Bitin 0.237 mg; Folic acid 1.53 mg; Nicotine acid 88.2 mg; Pantoteic acid 21.3 mg; cholin 1 564 mg; Linolic acid 2 805 mg; Ash 42.9 g.

### First Trial

Pigs ([Yorkshire×Swedish Landrace]×Hampshire)(n=10×3 were fed twice daily 2% of their body weight with the respective diets (either low or high methionine diets), water ad libitum.

| PIGS | n = 10 | n = 10 | n = 10 |
|---|---|---|---|
| Starting body wt | Low methinine | High methinine | High methinine |
| ca 40 kg | LM | DLM | HMTBA |
| Cage adaptation | Standard SE diet | Standard SE diet | Standard SE diet |
| (body wt ca 40 kg) | | | |
| Day 1 - treatment start | LM diet | DLM diet | HMTBA diet |
| (body wt ca 70 kg) | sEMG registration | sEMG registration | sEMG registration |
| | (n = 7) on the | (n = 7) on the | (n = 7) on the |
| | last adaptation day | last adaptation day | last adaptation day |
| | (day 1) and last | and last treatment | and last treatment |
| | treatment day | day on all pigs | day on all pigs |
| | (day 7) on all pigs. | | |
| Day 8 - treatment finish | LM diet | DLM diet | HMTBA diet |
| (body wt ca 75 kg) | 7 animals | 7 animals | 7 animals |
| | slaughtered | slaughtered | slaughtered |

### Second Trial

Pigs ([Yorkshire×Swedish Landrace]×Hampshire)(n=10×3 were fed twice daily 2% of their body weight with the respective diets (either low or high methionine diets), water ad libitum.

| PIGS | n = 10 | n = 10 | n = 10 |
|---|---|---|---|
| Starting body wt | Low methinine | High methinine | High methinine |
| 40 kg | LM | DLM | HMTBA |
| Cage adaptation | Standard SE diet | Standard SE diet | Standard SE diet |
| (body wt ca 40 kg) | | | |
| Day 1 - treatment start | LM diet | DLM diet | HMTBA diet |
| (body wt ca 70 kg) | Blood sampling | Blood sampling | Blood sampling |
| | (7 ml to heparin | | |
| | tube + 7 ml to | | |
| | EDTA tube) | | |
| Day 8 - treatment finish | LM diet | DLM diet | HMTBA diet |
| (body wt ca 75 kg | Blood sampling | Blood sampling | Blood sampling |

sEMG Measurements:

sEMG measurements were made on each pig after the morning meal. An area of the right-hand M. Longissimus dorsi muscle was shaved and sand-papered, after which, two recording electrodes were placed just in front of the last rib, and above the bulk of the M. Longissimus dorsi, and a reference electrode was placed on the back of the pigs' ear.

Two square stimulating electrodes were placed next to one another (not touching) and infront of the recording electrodes, after which the muscle was stimulated at 10, 20, 60, 150 and 200 Hz and the subsequent responses were recorded. Two leads were placed on either side of the abdomen at a position of the last rib to form a “triangle” with the reference electrode and serve to record both respiratory movements as well as sECG signal.

### Methods

sEMG Recordings

This study used both a single and a double differential electrode configuration, with electrodes (N-00-S & R-00-S; Blue Sensor, Medicotest A/S, Ølstykke, Denmark) configured as described previously by Harrison et al. (Harrison, A. P., A. H. Nielsen, I. Eidemak, S. Molsted, & E. M. Bartels. The uremic environment and muscle dysfunction in man and rat. Nephron. Vol 103: 33-42, 2006). Surface electromyography recordings were taken via an ML 132 amplifier connected to a ML780 PowerLab/8s A/D converter (AD Instruments, Chalgrove, Oxfordshire, UK) with a further connection to a MacBook Air with Chart v. 3.6.3/s Software, Peak Parameters and Spike Histogram extensions. Input impedance was 200 MS2 differential, and a high and a low pass filter of 3 Hz and 500 Hz, respectively, were used. Sampling speed was set to 40,000 per second.

sEMG Measurements

The guidelines laid out in the European Recommendations for Surface ElectroMyoGraphy as detailed by the SENIAM project by Hermens et al. (1999, Hermens H J, Freriks B, Merletti R, et al: SENIAM 8 European Recommendations for Surface ElectroMyoGraphy. Published by Roessingh Research and Development b.v. ISBN 90-75452-15-2), which document the optimal placement of sensors, including sensor size, individual muscle locations and both recording and analysis procedures, were closely followed.

Differential recordings of sEMG signals were made via surface electrodes from the L. dorsi muscle as previously described by Andersen et al. (2008, Andersen N K, Ravn L S, Guy J H, Edwards S A & Harrison A P, Postnatal changes in electromyographic signals during piglet growth, and in relation to muscle fibre types. Livestock Science 115: 301-312). Non-invasive evoked sEMG measurements were obtained using a stimulation frequency of 60, 150 and 200 Hz, which in turn gave rise to evoked compound muscle action potentials (CMAP's), also referred to as M waves, being the collected activity of a large number of motor units. In brief, a bipolar differential electrode configuration, with disposable Ag—AgCl recording electromyography electrodes was attached to the exposed skin surface above the L. dorsi muscle, with a set inter-electrode distance of 16-19 mm (Andersen et al., 2008). The ground electrode, used to minimize any common mode disturbance signal, was placed on the pigs' ears. The stimulation was conducted over a range of set frequencies (Hz) (Digitimer DS3 isolated stimulator, Digitimer Ltd, UK), with 2 ms pulses of 32 mA via Palsflex electrodes (Danmeter, DK).

sEMG Signal Analysis

The recorded sEMG signal was assessed in terms of peak-to-peak amplitude (mV) using Chart analysis software (AD Instruments, Chalgrove, Oxfordshire, UK).

Respiration & sECG Analysis

Using electrodes placed either side of the abdomen at the position of the last rib, and a reference electrode placed on the ear, it was possible to create an Einthoven triangle and to record both an ECG (plus heart rate) and respiration rate through diaphragm movements. The recorded signal was assessed in terms of rate and the Q-T interval (time taken for the ventricles to depolarize and repolarize) using Chart analysis software (AD Instruments, Chalgrove, Oxfordshire, UK).

### Results

sEMG Measurements

The EMG measurements detected changes in surface EMG recordings of the L. dorsi muscle of the pigs following each treatment (DLM & HMTBA) cf untreated CONTROLS. See FIG. 2. From FIG. 2 it is clear to see that rapid changes in amplitude (mV) measured at various frequencies occur between the various treatment groups.

Note that the CONT (untreated) and the Treatment (DLM) pre groups have a similar signal response e.g. without or prior to treatment the L. dorsi muscle responds in a similar fashion to electrical stimulation.

There is, however, a clear improvement in sEMG peak-to-peak amplitude between the Treatment (DLM) pre and post groups (yellow versus blue), indicating a clear benefit in terms of muscle growth/performance of 1 weeks dieatry supplementation with DLM.

Of particular interest though is the even greater improvement in muscle growth/performance that was seen with 1 weeks dietary supplementation with HMTBA—almost a 100% improvement cf CONT (untreated) levels.

### Respiration & ECG Analysis

In addition to the sEMG recordings, we were able to obtain non-invasive measurements of the rate of respiration (breaths/min) and the heart rate (bpm) as well as an analysis of the recorded ECG in terms of the time taken for ventricle depolarization and repolarization, the so-called Q-T interval.

TABLE 1
Effects of 1 weeks dietary supplementation

| | Respiration | Heart Rate | Q-T Interval |
|---|---|---|---|
| Groups | (breaths/min) | (bpm) | (msec) |
| Treatment (DLM) | 26.83 | 121.17 | 223.21 |
| pre (n = 6) | | | |
| Treatment (DLM) | 23.53 | 110.11 | 242.31 |
| post (n = 6) | | | |
| Difference | DECREASE by | DECREASE by | INCREASE by |
| | 12% (ns) | 9% (ns) | 8.5% P < 0.01 |

Table 1 presents the effects of 1 weeks dietary supplementation with DLM on the respiration and heart rate of 90-100 kg slaughter weight pigs, as well as the Q-T Interval. Values are the mean of a number of pigs, where “n” represents the number of animals per group. (ns) represents a difference between means that was not quite significant.

From Table 1, it can be seen that the 1 week's dietary supplementation with DLM resulted in such physiological changes in these slaughter weight pigs as a reduction in the rate of respiration, a slower and calmer heart rate, and a longer Q-T interval, all of which are indicative of a relaxed physiological state.

Indeed, whilst only the change in the Q-T interval is significant statistically in the current limited data set, taken as a whole these data are quite remarkable as they show that despite the considerable stress of being caught (holding rope over the nose & bodily manipulation; being chased prior to capture) and the restraint imposed by the recording sling, plus the presence of 5-6 people at close proximity, and finally electrical stimulation of L. dorsi, the treated pigs show physiological signs of being less stressed.

Thus, the methionine DLM diet clearly seems to have a calmative/anti-stress effect on these slaughter weight pigs, which were exposed to exactly the same level of handling and measurement stress as the untreated pigs.

### Meat Quality

### Methods

The pigs were slaughtered at a commercial slaughter house in Sweden after a resting time of 5 h. At 45 minutes post mortem, pH (Knick portamess 751) and temperature (digital thermometer, Weber) were measured in the M. longissiumus dorsi at the level of the 10^{th} rib. At 48 h post mortem, the entire loins were dissected from the carcasses and transported to the University of Copenhagen for further measurements. Ultimate pH was measured, as well as colour by Minolta L*a*b*. Dry matter content was determined by drying muscle samples at 105° C. for 24 h. Slices of 3 cm thickness were cut, measured and vacuum packed before being stored for a further 7 days at 2° C. At the end of the storage period samples were heated to an internal temperature of 75° C. After being cooled down, samples were stored cold at 2° C. until they were cut into slabs of 1 cm×1 cm×2.5 cm size for shear force measurement. For each animal, 8 specimens were measured and the mean maximum load was used for further analysis. However, in the case that any of the specimens had a maximum load which was more than 2 standard deviations from the mean, those specimens were regarded as outliers and taken out of the calculation.

### Results

No significant effect of the different feeding regimens could be observed on early parameters of meat quality (Table 2). None of the pigs developed the PSE syndrome as the early post mortem pH remained above 5.8 in all cases, although the carcass temperature was slightly elevated. This then proves that the slightly higher carcass temperature in this particular case was not due to stress during transport and/or waiting time, but rather the scalding procedure, which was performed with hot water.

TABLE 2
Influence of DLM and HMTNA supplementation
on meat quality parameters

| | Time | | | | |
|---|---|---|---|---|---|
| | post | Feeding Regimen | | | Statistical |
| | mortem | DLM | Control | HMTBA | significance |
| Slaughter house | 45 min | | | | |
| pH | | 6.10 | 6.30 | 6.20 | n.s. |
| Temperature (° C.) | | 39 | 38 | 39 | n.s. |
| Laboratory | 2 days | | | | |
| pH | | 5.50 | 5.40 | 5.40 | n.s. |
| Colour (units) | | | | | |
| Minolta L* | | 55.75 | 54.64 | 56.89 | n.s. |
| Minolta a* | | 6.69 | 7.56 | 7.58 | n.s. |
| Minolta b* | | 2.92 | 3.00 | 3.71 | n.s. |
| Dry Matter (%) | | 26 | 26 | 29 | n.s. |
| After Storage | 9 days | | | | |
| Maximum Load (N) | | 34 | 46 | 37 | P < 0.02 |

All of the measurements taken at 2 days post mortem are within the “normal” range, moreover, none of the M. longissimus dorsi showed signs of DFD meat, and the colour measurements were also found to be normal.

The slightly higher ultimate pH of the DLM group is an advantage on terms of processed products, while the lower pH of the other groups might be expected to give the meat a better flavour.

The higher dry matter content of the HTMBA group might be explained in terms of a higher intramuscular fat content, as this group showed higher gains during the finishing period.

After 7 days of storage, both of the groups that had been fed the high methionine supplemented diet showed evidence of a superior eating quality compared with that of the control group (see FIG. 3). This is indicated by the lower shearforce values of the DLM (1) and HMTBA (3) groups compared with that of the controls (2).

### CONCLUSIONS

### sEMG Measurements

As a result of the sEMG data, a high methionine (DLM (i.e. DL-methionine) or HMTBA (i.e. 2-hydroxy-4-(methylthio) butanoic acid)) diet has to be administered to pigs, one to two weeks prior to ‘stressful’ situations such as weaning, relocation and slaughter; in order to minimize the damage resulting from the oxidation of methionine residues in muscle membrane channels, essential in the normal functioning of muscle and in order to provide a calmative for pigs prior to stressful situations.

Respiration & sECG Analysis

One week dietary supplementation with DLM resulted in such physiological changes in the slaughter weight pigs as; 1) a reduction in the rate of respiration, 2) a slower and calmer heart rate, and 3) a longer Q-T interval, all of which are indicative of a relaxed physiological state.

Clearly the methionine diet has calmative effects/benefits for those needing to transport slaughter pigs any distance to the abattoir.

### Meat Quality

Methionine supplementation during the finishing period of fattening pig production results in superior textural properties of the meat after storage.

1. A method for improving the tenderness of meat which comprises the step of administering methionine as a pre-slaughter diet to an animal.

2. The method according to claim 1, wherein the meat is avian meat or fish meat or non-human mammal.

3. The method according to claim 1, wherein the meat is selected from the group consisting of pork, beef, hen, chicken, turkey, fish.

4. The method according to claim 1, wherein the methionine is administered in the form of a methionine supplementation formulation.

5. The method according to claim 1, wherein the administered methionine is in the form of L-methionine, or in the form of synthetic methionine sources such as OLM (i.e. DL-methionine) or all of its salt 15 forms, its analogues (e.g. 2-Hydroxy-4-Methyl Thio Butanoic acid or all its salt forms), its derivatives (e.g. 2-Hydroxy-4-Methyl Thio Butanoic isopropyl ester or any of other esters), or mixtures thereof.

6. The method according to claim 1, wherein the methionine is administered as 0.1-1 g of total methionine per kg body weight per day 20 pre-slaughter to the animal.

7. The method according to claim 1, wherein the methionine is administered to the animal as 0.3-0.6% above recommended daily dose.

8. The method according to claim 1, wherein the methionine is administered on day −30 to −1 pre-slaughter.

9. The method according to claim 1, wherein the administration of methionine is done orally to the animal.

10. An animal pre-slaughter diet comprising methionine and wherein the methionine is fed on day −30 to −1 pre-slaughter in a dose of 0.1-1 g per kg body weight per day to the animal or in a dose of 0.3-0.6% above 30 recommended daily dose intake.

11. The pre-slaughter diet of claim 10, further comprising at least one further feed stuff to the animal.

12. Meat from a slaughtered animal, said animal being fed with a preslaughter diet comprising methionine according to claim 10.

13. A product comprising meat at least partially from a slaughtered animal, said animal being fed with a pre-slaughter diet comprising methionine 5 according to claim 10.

14. Use of methionine for improving the tenderness of avian meat or fish meat or non-human mammal.

15. The use according to claim 14, wherein the methionine is in the form of L-methionine, or in the form of synthetic methionine sources such as 10 OLM or all of its salt forms, its analogues (e.g. 2-Hydroxy-4-Methyl Thio Butanoic acid or all its salt forms), its derivatives (e.g. 2-Hydroxy-4-Methyl Thio Butanoic isopropyl ester or any of other esters), or mixtures thereof.
